(19) United States
(12) Patent Application Publication
(10) Pub. No.: US 2025/0298283 A1
(43) Pub. Date: Sep. 25, 2025

(54) FLEXIBLE DISPLAY DEVICE AND MANUFACTURING METHOD THEREOF

(71) Applicant: E Ink Holdings Inc., HSINCHU (TW)

(72) Inventors: Wei-Sung CHENG, HSINCHU (TW); Ming-Huan YANG, HSINCHU (TW); Yi-Sheng LIN, HSINCHU (TW)

(21) Appl. No.: 19/063,270

(22) Filed: Feb. 25, 2025

(30) Foreign Application Priority Data
Mar. 22, 2024 (TW) 113110898

(51) Int. Cl. G02F 1/16755; G02F 1/167; G02F 1/1679

(52) U.S. Cl. CPC G02F 1/16755; G02F 1/167; G02F 1/1679

(57) ABSTRACT

A flexible display device includes a flexible substrate, a light transmissive plate, a display medium layer, a transparent conductive layer, a conductive film, and a protection structure. The display medium layer is located between the light transmissive plate and the flexible substrate. The transparent conductive layer is located on the bottom surface of the light transmissive plate. The conductive film includes a first horizontal portion on the top surface of the display medium layer, a vertical portion on the sidewall of the display medium layer, and a second horizontal portion on the top surface of the flexible substrate. The first horizontal portion is electrically connected to the transparent conductive layer. The second horizontal portion is electrically connected to the conductive area of the flexible substrate. The protection structure is located on the second horizontal portion and the flexible substrate.

### CROSS-REFERENCE TO RELATED APPLICATION

This application claims priority to Taiwan Application Serial Number 113110898, filed Mar. 22, 2024, which is herein incorporated by reference.

### BACKGROUND

### Field of Invention

The present disclosure relates to a flexible display device and a manufacturing method of the flexible display device.

### Description of Related Art

In today's market of various consumer electronic products, flexible display devices have been widely used as display screens in portable electronic devices, such as e-books. Since an electronic paper display device uses incident light to irradiate an electronic ink layer to achieve the purpose of display, the electronic paper display device does not need a backlight source, and can save power consumption. The incident light may be sunlight or indoor ambient light.

In order to realize narrow frame design, the flexible display device can be packaged in a bending manner on one side having a driving circuit, such as chip on glass (COG), chip on film (COF), chip on plastic (COP), etc. Packaging by chip on plastic is performed to bend the side of a flexible substrate having the driving circuit to the back of the display device, which has the best narrow bezel effect. However, the bending area of the flexible substrate easily causes damages to the peripheral circuits of a chip due to larger local stress, resulting in defects formed in a display area under long-term operation. In addition, silver glue used to electrically connect an upper electrode and a lower electrode cannot be bent, which is not conducive to narrow bezel design.

### SUMMARY

According to some embodiments of the present disclosure, a flexible display device includes a flexible substrate, a light transmissive plate, a display medium layer, a transparent conductive layer, a conductive film, and a protection structure. The flexible substrate has a conductive area. The light transmissive plate is located above the flexible substrate. The display medium layer is located between the light transmissive plate and the flexible substrate. The transparent conductive layer is located on the bottom surface of the light transmissive plate. The conductive film includes a first horizontal portion on the top surface of the display medium layer, a vertical portion on the sidewall of the display medium layer, and a second horizontal portion on the top surface of the flexible substrate. The first horizontal portion is electrically connected to the transparent conductive layer. The second horizontal portion is electrically connected to the conductive area of the flexible substrate. The protection structure is located on the second horizontal portion of the conductive film and the flexible substrate.

In some embodiments, the flexible display device further includes a sealant layer located between the protection structure and the vertical portion of the conductive film.

In some embodiments, a material of the protection structure is different from a material of the sealant layer so as to form an interface.

In some embodiments, a top surface of the sealant layer is coplanar with a top surface of the protection structure.

In some embodiments, a top surface of the sealant layer is coplanar with a top surface of the light transmissive plate.

In some embodiments, the protection structure has an extending portion located on a top surface of the sealant layer and in contact with a sidewall of the light transmissive plate.

In some embodiments, a top surface of the extending portion of the protection structure is coplanar with a top surface of the light transmissive plate.

In some embodiments, the protection structure comprises at least one water vapor barrier film and at least one protection film, and the protection film is stacked on the water vapor barrier film.

In some embodiments, the protection structure includes a plurality of the water vapor barrier films and a plurality of the protection films, and the water vapor barrier films are alternatively stacked with the protection films.

In some embodiments, a thickness of each of the protection film and the water vapor barrier film is greater than 10 μm, a Young's modulus of the protection film is greater than 30 MPa, and a Young's modulus of the water vapor barrier film is greater than 0.1 MPa.

In some embodiments, the protection structure extends to the vertical portion of the conductive film and a sidewall of the light transmissive plate.

In some embodiments, the protection structure is made of a same material and is integrally formed as a single piece.

In some embodiments, a top surface of the protection structure is coplanar with a top surface of the light transmissive plate.

According to some embodiments of the present disclosure, a manufacturing method of a flexible display device includes forming a display medium layer on a flexible substrate; forming a conductive film comprising a first horizontal portion, a vertical portion, and a second horizontal portion, wherein the first horizontal portion is located on a top surface of the display medium layer, the vertical portion is located on a sidewall of the display medium layer, and the second horizontal portion on a top surface of the flexible substrate; forming a transparent conductive layer on a bottom surface of a light transmissive plate; attaching light transmissive plate to the display medium layer; disposing a mold on the flexible substrate, wherein a portion of the mold is located above the second horizontal portion of the conductive film, and the mold has a feed inlet; injecting a protection glue through the feed inlet of the mold; curing the protection glue to form a protection structure, wherein the protection structure is located on the second horizontal portion of the conductive film and the flexible substrate; and removing the mold.

In some embodiments, the manufacturing method of the flexible display device further includes forming a sealant layer between the protection structure and the vertical portion of the conductive film.

In some embodiments, forming the sealant layer is performed such that a top surface of the sealant layer is coplanar with a top surface of the light transmissive plate, and is coplanar with a top surface of the protection structure.

In some embodiments, disposing the mold on the flexible substrate is performed such that said portion of the mold further covers the light transmissive plate.

In some embodiments, injecting the protection glue through the feed inlet of the mold is performed such that the protection glue extends to the vertical portion of the conductive film and a sidewall of the light transmissive plate.

In some embodiments, injecting the protection glue through the feed inlet of the mold is performed such that a top surface of the protection glue is coplanar with a top surface of the light transmissive plate.

In some embodiments, the mold has an air suction port, and the manufacturing method of the flexible display device further includes after disposing the mold on the flexible substrate, evacuating a space in the mold through the air suction port of the mold.

In the aforementioned embodiments of the present disclosure, since the first horizontal portion of the conductive film is electrically connected to the transparent conductive layer, the second horizontal portion is electrically connected to the conductive area of the flexible substrate, and the protection structure is located on the second horizontal portion of the conductive film and the flexible substrate, the range of a bending area is not limited by traditional silver glue to facilitate narrow bezel design. Moreover, the protection structure has the functions of stress adjustment and water vapor blocking, which can prevent the bending area from having larger local stress to cause damages to peripheral circuits. In addition, the protection structure is formed by disposing the mold on the flexible substrate and then injecting the protection glue through the feed inlet of the mold. As a result, the design value of the protection structure (e.g., thickness) can be determined by the mold. Compared with a traditional coating process for reaching a design value, the flexible display device and the manufacturing method thereof can simplify process steps and process parameter test time, and can increase tact time.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a flexible display device according to one embodiment of the present disclosure.

FIG. 2 is a cross-sectional view at an intermediate stage of the manufacturing method of the flexible display device of FIG. 1.

FIG. 3 is a cross-sectional view of a flexible display device according to another embodiment of the present disclosure.

FIG. 4 is a cross-sectional view at an intermediate stage of the manufacturing method of the flexible display device of FIG. 3.

FIG. 5 is a cross-sectional view of a flexible display device according to still another embodiment of the present disclosure.

FIG. 6 is a partially enlarged view of a protection structure of FIG. 5.

FIG. 7 is a cross-sectional view of a flexible display device according to yet another embodiment of the present disclosure.

FIG. 8 is a partially enlarged view of the protection structure of FIG. 7.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

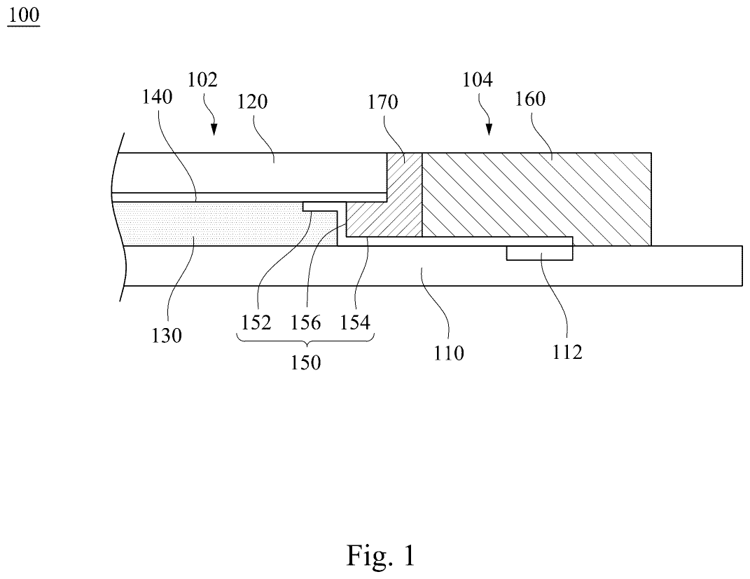

FIG. 1 is a cross-sectional view of a flexible display device 100 according to one embodiment of the present disclosure. As shown in FIG. 1, the flexible display device 100 includes a flexible substrate 110, a light transmissive plate 120, a display medium layer 130, a transparent conductive layer 140, a conductive film 150, and a protection structure 160. The flexible display device 100 has a display area 102 and a bending area 104. The display area 102 may display images, and the bending area 104 may be bent downward (e.g., in a clockwise direction) to the bottom of the display area 102. The flexible substrate 110 has a conductive area 112 in the bending area 104. The conductive area 112 may be electrically connected to the bottom electrode (pixel electrode) of the flexible substrate 110. The light transmissive plate 120 is located above the flexible substrate 110. The display medium layer 130 is located between the light transmissive plate 120 and the flexible substrate 110, and may include microcapsules having charged particles with different colors. The transparent conductive layer 140 is located on the bottom surface of the light transmissive plate 120, and serves as a top electrode (common electrode).

The conductive film 150 includes a first horizontal portion 152, a second horizontal portion 154, and a vertical portion 156. The first horizontal portion 152 is located on the top surface of the display medium layer 130. The second horizontal portion 154 on the top surface of the flexible substrate 110. The vertical portion 156 is located on the sidewall of the display medium layer 130 and adjacent to the first horizontal portion 152 and the second horizontal portion 154. The first horizontal portion 152 of the conductive film 150 is electrically connected to the transparent conductive layer 140. The second horizontal portion 154 of the conductive film 150 is electrically connected to the conductive area 112 of the flexible substrate 110. As a result, the conductive film 150 may be electrically connected to the top electrode and the bottom electrode in the display area 102.

The protection structure 160 is located on the second horizontal portion 154 of the conductive film 150 and the flexible substrate 110, and is located in the bending area 104. The protection structure 160 overlaps the conductive area 112 and the second horizontal portion 154 of the conductive film 150 in the bending area 104 in a vertical direction to provide protection. Specifically, since the first horizontal portion 152 of the conductive film 150 is electrically connected to the transparent conductive layer 140, the second horizontal portion 154 is electrically connected to the conductive area 112 of the flexible substrate 110, and the protection structure 160 is located on the second horizontal portion 154 of the conductive film 150 and the flexible substrate 110, the range of the bending area 104 is not limited by traditional silver glue to facilitate narrow bezel design. Moreover, the protection structure 160 has the functions of stress adjustment and water vapor blocking, which can prevent the bending area 104 from having larger local stress to cause damages to peripheral circuits.

In this embodiment, the flexible display device 100 further includes a sealant layer 170. The sealant layer 170 is located between the protection structure 160 and the vertical portion 156 of the conductive film 150, and extends to a position between the light transmissive plate 120 and the protection structure 160. The material of the protection structure 160 is different from the material of the sealant layer 170 so as to form an interface. The top surface of the sealant layer 170 is coplanar with the top surface of the protection structure 160, and is coplanar with the top surface of the light transmissive plate 120, thereby facilitating flat design. In FIG. 1, an area at the right side of the sealant layer 170 may be the bending area 104 of the flexible display device 100.

In the following description, the manufacturing method of the flexible display device 100 will be explained.

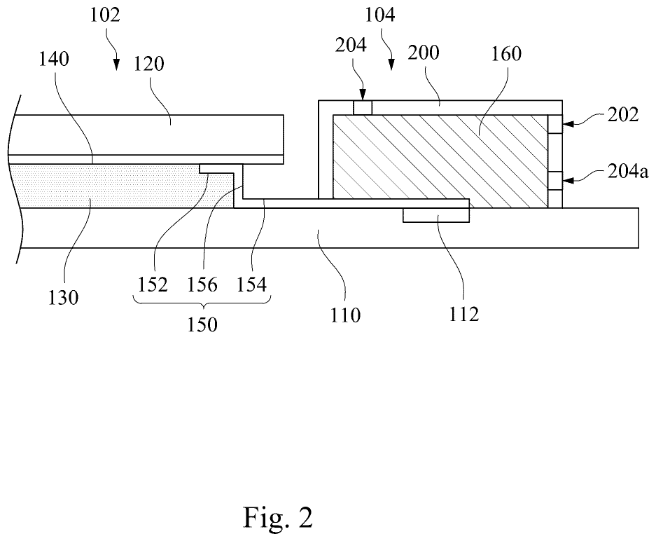

FIG. 2 is a cross-sectional view at an intermediate stage of the manufacturing method of the flexible display device 100 of FIG. 1. The manufacturing method of the flexible display device 100 includes forming the display medium layer 130 on the flexible substrate 110. For example, the material of the flexible substrate 110 may be, but not limited to polyimide (PI). The flexible substrate 110 may have a thin film transistor (TFT) array on its surface in the display area 102. Thereafter, the conductive film 150 including the first horizontal portion 152, the vertical portion 156, and the second horizontal portion 154 is formed. For example, the material of the conductive film 150 may be conductive polymer (e.g., 3,4-ethylenedioxythiophene; PEDOT). This material has fluidity and volatility before baking, and can be dispensed toward the bending area 104 from the top surface of the display medium layer 130 to the conductive area 112 of the flexible substrate 110. Furthermore, the transparent conductive layer 140 may be formed on the bottom surface of the light transmissive plate 120, in which the material of the transparent conductive layer 140 may be indium tin oxide (ITO), for example. Afterwards, the light transmissive plate 120 is attached to the display medium layer 130. Subsequently, the aforementioned conductive polymer can be baked such that the conductive film 150 has the function of driving display panel.

Thereafter, a mold 200 is disposed on the flexible substrate 110, wherein a portion of the mold 200 (e.g., the top portion) is located above the second horizontal portion 154 of the conductive film 150, and the mold 200 has a feed inlet 202. Then, a protection glue is injected through the feed inlet 202 of the mold 200. Subsequently, the protection glue is cured to form the protection structure 160, such that the protection structure 160 is located on the second horizontal portion 154 of the conductive film 150 and the flexible substrate 110. Specifically, because the protection structure 160 is formed by disposing the mold 200 on the flexible substrate 110 and then injecting the protection glue through the feed inlet 202 of the mold 200, the design value of the protection structure 160 (e.g., thickness) can be determined by the mold 200. Compared with a traditional coating process for reaching a design value, the flexible display device 100 (see FIG. 1) and the manufacturing method thereof can simplify process steps and process parameter test time, and can increase tact time.

In some embodiments, the mold 200 has air suction ports 204 and 204a. After the mold 200 is disposed on the flexible substrate 110, the space in the mold 200 may be evacuated through at least one of the air suction ports 204 and 204a of the mold 200. The evacuating step may be performed before injecting the protection glue, or evacuating the space in the mold 200 and injecting the protection glue are alternatively performed, and the present disclosure is not limited in this regard.

After the formation of the protection structure 160, the mold 200 may be removed. The inner surface of the mold 200 may be coated with a material that is easy to separate from the protection structure 160. In some embodiments, the parameters of curing the protection glue can be adjusted to achieve the purpose of releasing the mold 200 after being filled.

As shown in FIG. 1 and FIG. 2, after the mold 200 is removed, the sealant layer 170 is formed between the protection structure 160 and the vertical portion 156 of the conductive film 150, and between the light transmissive plate 120 and the protection structure 160. The material of the sealant layer 170 may be, but not limited to epoxy resin. The step of forming the sealant layer 170 can enable the top surface of the sealant layer 170 to be coplanar with the top surface of the light transmissive plate 120, and coplanar with the top surface of the protection structure 160.

It is to be noted that the connection relationships, the materials, and the advantages of the elements described above will not be repeated in the following description. In the following description, other types of flexible display devices will be explained.

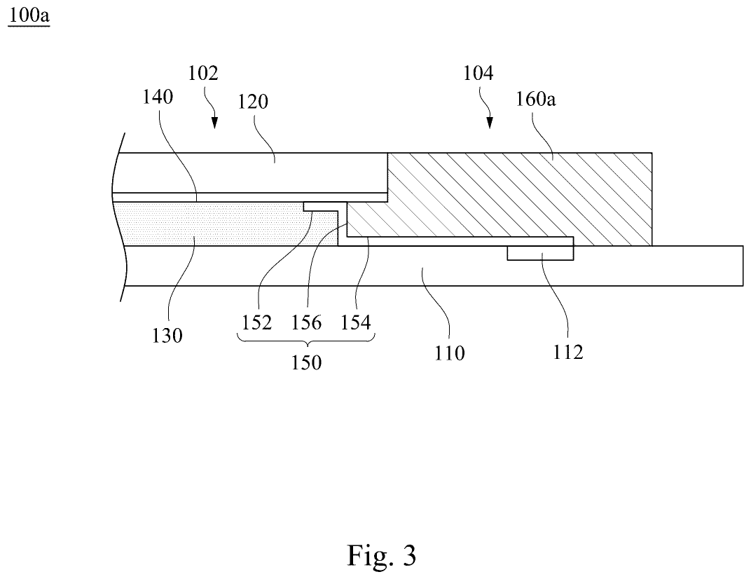

FIG. 3 is a cross-sectional view of a flexible display device 100a according to another embodiment of the present disclosure. The flexible display device 100a includes the flexible substrate 110, the light transmissive plate 120, the display medium layer 130, the transparent conductive layer 140, the conductive film 150, and a protection structure 160a. The difference between this embodiment and the embodiment shown in FIG. 1 is that the flexible display device 100a has no sealant layer 170 of FIG. 1, and the protection structure 160a extends to the vertical portion 156 of the conductive film 150 and the sidewall of the light transmissive plate 120. In addition, the top surface of the protection structure 160a may be coplanar with the top surface of the light transmissive plate 120, and the protection structure 160a is made of the same material and is integrally formed as a single piece.

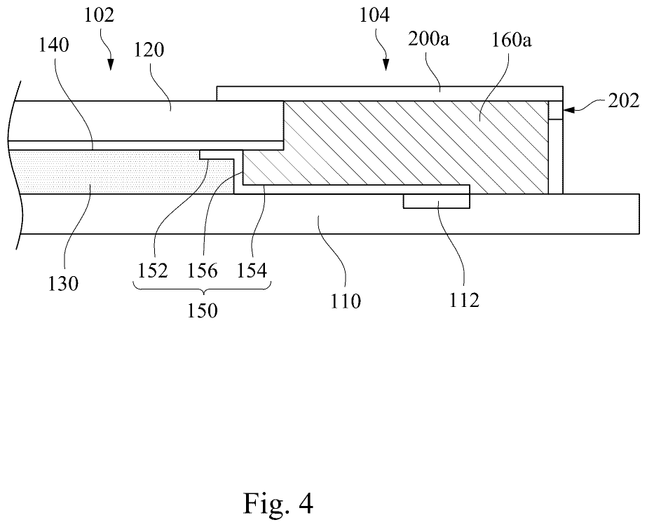

FIG. 4 is a cross-sectional view at an intermediate stage of the manufacturing method of the flexible display device 100a of FIG. 3. The difference between this embodiment and the embodiment shown in FIG. 2 is that after the light transmissive plate 120 is attached to the display medium layer 130, disposing a mold 200a on the flexible substrate 110 is performed such that a portion (e.g., top portion) of the mold 200a further covers the light transmissive plate 120. In such a design, in the step of injecting the protection glue through the feed inlet 202 of the mold 200a, the protection glue can extends to the vertical portion 156 of the conductive film 150 and the sidewall of the light transmissive plate 120, and the top surface of the protection glue can be coplanar with the top surface of the light transmissive plate 120. After curing, the protection glue forms the protection structure 160a.

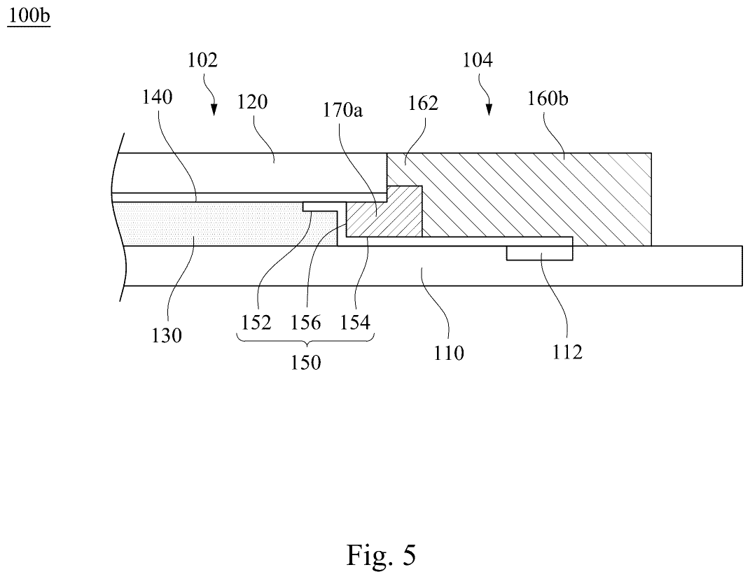

FIG. 5 is a cross-sectional view of a flexible display device 100b according to still another embodiment of the present disclosure. The flexible display device 100b includes the flexible substrate 110, the light transmissive plate 120, the display medium layer 130, the transparent conductive layer 140, the conductive film 150, a protection structure 160b, and a sealant layer 170a. The difference between this embodiment and the embodiment shown in FIG. 1 is that the protection structure 160b has an extending portion 162, and the extending portion 162 is located on the top surface of the sealant layer 170a and in contact with the sidewall of the light transmissive plate 120. Moreover, the top surface of the extending portion 162 of the protection structure 160b may be coplanar with the top surface of the light transmissive plate 120. In this embodiment, the top surface of the sealant layer 170a is lower than the top surface of the light transmissive plate 120, and is higher than the bottom surface of the light transmissive plate 120.

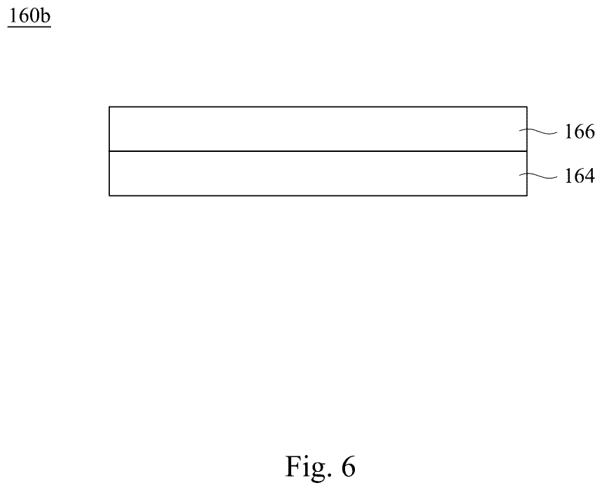

FIG. 6 is a partially enlarged view of the protection structure 160b of FIG. 5. The protection structure 160b includes at least one water vapor barrier film 164 and at least one protection film 166, and the protection film 166 is stacked on the water vapor barrier film 164. In some embodiments, the thickness of each of the protection film 166 and the water vapor barrier film 164 is greater than 10 μm, the Young's modulus of the protection film 166 is greater than 30 MPa, and the Young's modulus of the water vapor barrier film 164 is greater than 0.1 MPa. In addition, the present disclosure is not limited by the number of the protection films 166 and the number of the water vapor barrier films 164. The protection films 166 and the water vapor barrier films 164 may be continuously stacked layers. The protection film 166 may be a functional layer without blocking water vapor, and includes acrylic, epoxy, or other polymer materials.

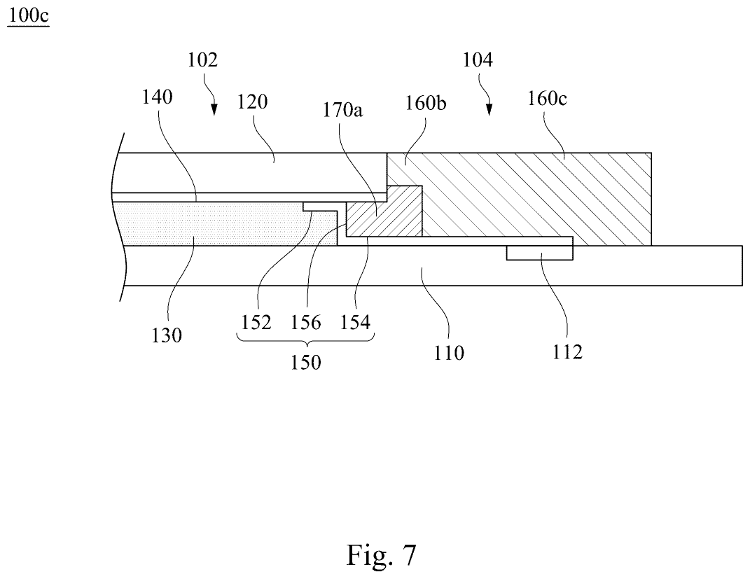

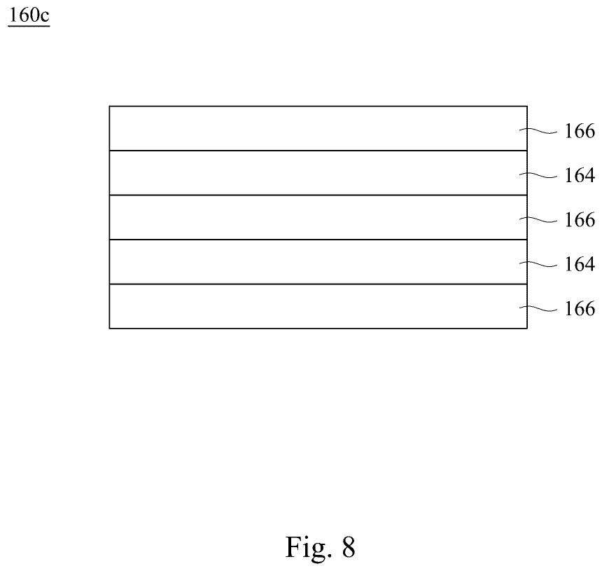

FIG. 7 is a cross-sectional view of a flexible display device 100c according to yet another embodiment of the present disclosure. FIG. 8 is a partially enlarged view of a protection structure 160c of FIG. 7. As shown in FIG. 7 and FIG. 8, the flexible display device 100c includes the flexible substrate 110, the light transmissive plate 120, the display medium layer 130, the transparent conductive layer 140, the conductive film 150, the protection structure 160c, and the sealant layer 170a. The difference between this embodiment and the embodiment shown in FIGS. 5 and 6 is that the protection structure 160c includes plural water vapor barrier films 164 and plural protection films 166, and the water vapor barrier films 164 are alternatively stacked with the protection films 166. In some embodiments, the thickness of each of the protection film 166 and the water vapor barrier film 164 is greater than 10 μm, the Young's modulus of the protection film 166 is greater than 30 MPa, and the Young's modulus of the water vapor barrier film 164 is greater than 0.1 MPa. Furthermore, the two water vapor barrier films 164 and the three protection films 166 shown in FIG. 8 are merely an example. The number of protection films 166 and the number of the water vapor barrier films 164 do not limit the present disclosure. The protection films 166 and the water vapor barrier films 164 may be continuously stacked layers.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A flexible display device, comprising:
a flexible substrate having a conductive area;
a light transmissive plate located above the flexible substrate;
a display medium layer located between the light transmissive plate and the flexible substrate;
a transparent conductive layer located on a bottom surface of the light transmissive plate;
a conductive film comprising a first horizontal portion on a top surface of the display medium layer, a vertical portion on a sidewall of the display medium layer, and a second horizontal portion on a top surface of the flexible substrate, wherein the first horizontal portion is electrically connected to the transparent conductive layer, and the second horizontal portion is electrically connected to the conductive area of the flexible substrate; and
a protection structure located on the second horizontal portion of the conductive film and the flexible substrate.

2. The flexible display device of claim 1, further comprising:
a sealant layer located between the protection structure and the vertical portion of the conductive film.

3. The flexible display device of claim 2, wherein a material of the protection structure is different from a material of the sealant layer so as to form an interface.

4. The flexible display device of claim 2, wherein a top surface of the sealant layer is coplanar with a top surface of the protection structure.

5. The flexible display device of claim 2, wherein a top surface of the sealant layer is coplanar with a top surface of the light transmissive plate.

6. The flexible display device of claim 2, wherein the protection structure has an extending portion located on a top surface of the sealant layer and in contact with a sidewall of the light transmissive plate.

7. The flexible display device of claim 6, wherein a top surface of the extending portion of the protection structure is coplanar with a top surface of the light transmissive plate.

8. The flexible display device of claim 1, wherein the protection structure comprises at least one water vapor barrier film and at least one protection film, and the protection film is stacked on the water vapor barrier film.

9. The flexible display device of claim 8, wherein the protection structure comprises a plurality of the water vapor barrier films and a plurality of the protection films, and the water vapor barrier films are alternatively stacked with the protection films.

10. The flexible display device of claim 8, wherein a thickness of each of the protection film and the water vapor barrier film is greater than 10 μm, a Young's modulus of the protection film is greater than 30 MPa, and a Young's modulus of the water vapor barrier film is greater than 0.1 MPa.

11. The flexible display device of claim 1, wherein the protection structure extends to the vertical portion of the conductive film and a sidewall of the light transmissive plate.

12. The flexible display device of claim 11, wherein the protection structure is made of a same material and is integrally formed as a single piece.

13. The flexible display device of claim 11, wherein a top surface of the protection structure is coplanar with a top surface of the light transmissive plate.

14. A manufacturing method of a flexible display device, comprising:
forming a display medium layer on a flexible substrate;
forming a conductive film comprising a first horizontal portion, a vertical portion, and a second horizontal portion, wherein the first horizontal portion is located on a top surface of the display medium layer, the vertical portion is located on a sidewall of the display medium layer, and the second horizontal portion on a top surface of the flexible substrate;
forming a transparent conductive layer on a bottom surface of a light transmissive plate;
attaching light transmissive plate to the display medium layer;
disposing a mold on the flexible substrate, wherein a portion of the mold is located above the second horizontal portion of the conductive film, and the mold has a feed inlet;
injecting a protection glue through the feed inlet of the mold;
curing the protection glue to form a protection structure, wherein the protection structure is located on the second horizontal portion of the conductive film and the flexible substrate; and
removing the mold.

15. The manufacturing method of the flexible display device of claim 14, further comprising:
forming a sealant layer between the protection structure and the vertical portion of the conductive film.

16. The manufacturing method of the flexible display device of claim 15, wherein forming the sealant layer is performed such that a top surface of the sealant layer is coplanar with a top surface of the light transmissive plate, and is coplanar with a top surface of the protection structure.

17. The manufacturing method of the flexible display device of claim 15, wherein disposing the mold on the flexible substrate is performed such that said portion of the mold further covers the light transmissive plate.

18. The manufacturing method of the flexible display device of claim 17, wherein injecting the protection glue through the feed inlet of the mold is performed such that the protection glue extends to the vertical portion of the conductive film and a sidewall of the light transmissive plate.

19. The manufacturing method of the flexible display device of claim 17, wherein injecting the protection glue through the feed inlet of the mold is performed such that a top surface of the protection glue is coplanar with a top surface of the light transmissive plate.

20. The manufacturing method of the flexible display device of claim 17, wherein the mold has an air suction port, and the manufacturing method of the flexible display device further comprises:
after disposing the mold on the flexible substrate, evacuating a space in the mold through the air suction port of the mold.
